(19) United States
(12) Patent Application Publication
(10) Pub. No.: US 2025/0068428 A1
(43) Pub. Date: Feb. 27, 2025

(54) CONSOLIDATION AND SHARING OF PIPELINES ACROSS PROJECTS IN A COMPUTING SYSTEM

(71) Applicant: VMWARE, INC., PALO ALTO, CA (US)

(72) Inventors: ADITI SRINIVAS, BANGALORE (IN); PRIYANK AGARWAL, BANGALORE (IN); KALYAN DEVARAKONDA, BANGALORE (IN); ANURAG SHARMA, BANGALORE (IN)

(21) Appl. No.: 18/379,197

(22) Filed: Oct. 12, 2023

(30) Foreign Application Priority Data
Aug. 25, 2023 (IN) 202341057041

(51) Int. Cl. G06F 9/38; G06F 9/455

(52) U.S. Cl. CPC G06F 9/3867; G06F 9/45558

(57) ABSTRACT

An example method of managing an automation pipeline in a computing system includes: receiving, at a pipeline manager, a definition of the pipeline having a plurality of stages, each of the plurality of stages having at least one task; receiving, at the pipeline manager, an indication that the pipeline is global across a plurality of projects; receiving, at an execution orchestrator, a request from a user to execute the pipeline; requesting, by the execution orchestrator from the user, a target project of the plurality of projects in which to execute the pipeline in response to the pipeline being global; and executing, by the execution orchestrator, the pipeline in the target project to deploy an application executing on virtualized infrastructure of the computing system.

### RELATED APPLICATIONS

Benefit is claimed under 35 U.S.C. 119(a)-(d) to Foreign Application Serial No. 202341057041 filed in India entitled “CONSOLIDATION AND SHARING OF PIPELINES ACROSS PROJECTS IN A COMPUTING SYSTEM”, on Aug. 25, 2023, by VMware, Inc., which is herein incorporated in its entirety by reference for all purposes.

### BACKGROUND

Applications today are deployed onto a combination of virtual machines (VMs), containers, application services, and more. For deploying such applications, a container orchestrator (CO) known as Kubernetes® has gained in popularity among application developers. Kubernetes provides a platform for automating deployment, scaling, and operations of application containers across clusters of hosts. It offers flexibility in application development and offers several useful tools for scaling.

Automation pipelines provide a continuous integration and continuous delivery (CI/CD) tool targeted for infrastructure and application pipeline use cases. Automated pipelines help in faster delivery and avoid manual configuration which is error prone. Pipelines include various tasks to be performed. Pipelines are grouped by project. Typically, a project is created by following an organizational structure, such as a cost center, specific business group, etc. Project membership is managed by assigning a project administrator, project member(s), and project viewer role(s), and the like. The project members can execute pipelines using the project's endpoints only. Hence, the pipeline of one project cannot be accessed in another project.

In an organization, the tasks in a pipeline remain almost the same. Since pipelines are unavailable across projects in an Org, the admin will create multiple copies of the same pipeline in different projects. When the admin tries to create a new pipeline, the admin typically does not know if there is any other pipeline in the same or different project that performs the same tasks. There is no easy way to find out what tasks are in a pipeline without going through each one. This

will also lead to the same problem of the admin creating copies of the same pipeline. There is no centralized configuration of the pipeline definition. Hence, managing automation pipelines is a non-trivial task for admins.

### SUMMARY

In an embodiment, a method of managing an automation pipeline in a computing system includes: receiving, at a pipeline manager, a definition of the pipeline having a plurality of stages, each of the plurality of stages having at least one task; receiving, at the pipeline manager, an indication that the pipeline is global across a plurality of projects; receiving, at an execution orchestrator, a request from a user to execute the pipeline; requesting, by the execution orchestrator from the user, a target project of the plurality of projects in which to execute the pipeline in response to the pipeline being global; and executing, by the execution orchestrator, the pipeline in the target project to deploy an application executing on virtualized infrastructure of the computing system.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtualized computing system in which embodiments described herein may be implemented.

FIG. 2 is a block diagram depicting automation pipeline software according to embodiments.

FIG. 3 is a block diagram depicting pipeline information for a pipeline according to embodiments.

FIG. 4 is a flow diagram depicting a method of creating a pipeline according to embodiments.

FIG. 5 is a flow diagram depicting a method of generating hashes for a pipeline according to embodiments.

FIG. 6 is a flow diagram depicting a method of executing a pipeline according to embodiments.

FIG. 7 is a flow diagram depicting a method of comparing pipelines according to embodiments.

FIG. 8 is a flow diagram depicting a method of comparing pipelines for unification according to embodiments.

### DETAILED DESCRIPTION

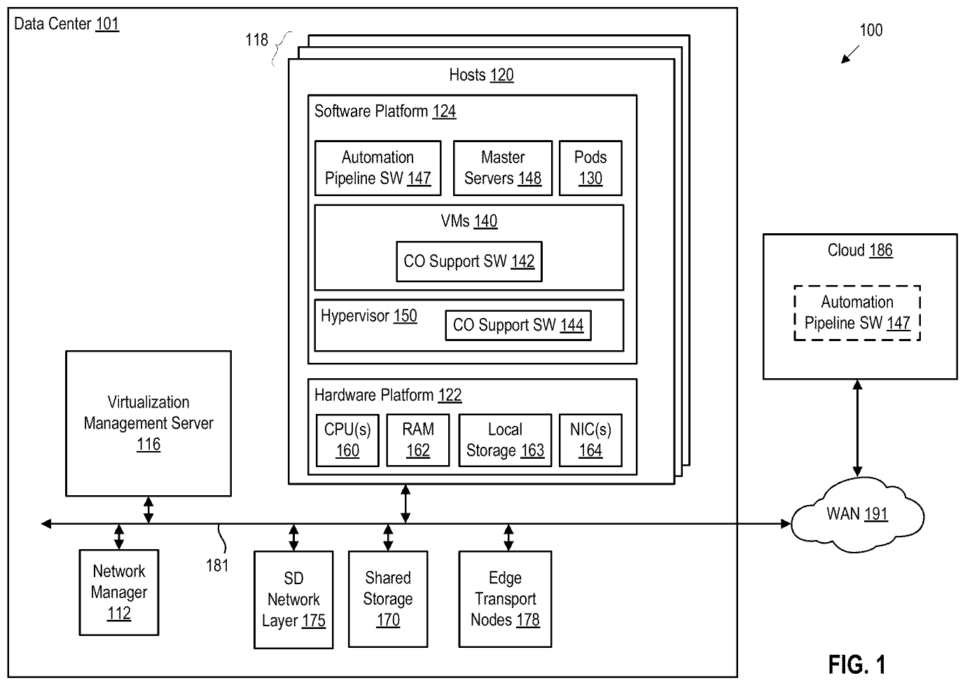

FIG. 1 is a block diagram of a virtualized computing system 100 in which embodiments described herein may be implemented. Virtualized computing system includes a data center 101. In embodiments, the data center 100 can be in communication with a cloud 186 through a wide area network (WAN) 191 (e.g. the public Internet).

Data center 101 includes hosts 120. Hosts 120 may be constructed on hardware platforms such as an x86 architecture platforms. One or more groups of hosts 120 can be managed as clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 181. Physical network 181 enables communication between hosts 120 and between other components and hosts 120 (other components discussed further herein).

In the embodiment illustrated in FIG. 1, hosts 120 access shared storage 170 by using NICs 164 to connect to network 181. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN, which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, CA.

Virtualized computing system 100 is configured with a software-defined (SD) network layer 175. SD network layer 175 includes logical network services executing on virtualized infrastructure of hosts 120. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to WAN 191. Edge transport nodes 178 can include a gateway (e.g., implemented by a router) between the internal logical networking of host cluster 118 and the external network. Edge transport nodes 178 can be physical servers or VMs. Virtualized computing system 100 also includes physical network devices (e.g. physical routers/switches) as part of physical network 181, which are not explicitly shown.

Virtualization management server 116 is a physical or virtual server that manages hosts 120 and the hypervisors therein. Virtualization management server 116 installs agent(s) in hypervisor 150 to add a host 120 as a managed entity. Virtualization management server 116 can logically group hosts 120 into host cluster 118 to provide cluster-level functions to hosts 120, such as V M migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118. While only one virtualization management server 116 is shown, virtualized computing system 100 can include multiple virtualization management servers each managing one or more host clusters.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. One example of an SD networking platform that can be configured and used in embodiments described herein as network manager 112 and SD network layer 175 is a VMware NSX® platform made commercially available by VMware, Inc. of Palo Alto, CA. In other embodiments. SD network layer 175 is orchestrated and managed by virtualization management server 116 without the presence of network manager 112.

In embodiments, applications execute in containers. For example, applications can be deployed as pods 130 by a container orchestrator (CO), such as Kubernetes. The CO control plane includes a master server 148 executing in host(s) 120. A master server 148 can execute in VM(s) 140 and includes various components, such as an application programming interface (AP), database, controllers, and the like. Automation pipeline software 147 can execute in VMs 140 (e.g., directly within VMs or within containers in VMs). Automation pipeline software 147 allows users to define automation pipelines, manage automation pipelines (e.g., update/delete, add/remote users, add/modify authorization data, etc.). Each automation pipeline (“pipeline”) includes a plurality of stages. Each stage of a pipeline executes one or more tasks. For example, a user can create an automation pipeline to deploy virtualized infrastructure and a CO cluster executing in the virtualized infrastructure. Each pipeline can be associated with a project. In embodiments, as described further herein, pipelines can be shared among projects.

In embodiments, VMs 140 include CO support software 142 to support execution of pods 130. CO support software 142 can include, for example, a container runtime, a CO agent (e.g., kubelet), and the like. In some embodiments, hypervisor 150 can include CO support software 144. In embodiments, hypervisor 150 is integrated with a container orchestration control plane, such as a Kubernetes control plane. This integration provides a “supervisor cluster” (i.e., management cluster) that uses VMs to implement both control plane nodes and compute objects managed by the Kubernetes control plane. For example, Kubernetes pods are implemented as “pod VMs,” each of which includes a kernel and container engine that supports execution of containers. The Kubernetes control plane of the supervisor cluster is extended to support VM objects in addition to pods, where the VM objects are implemented using native VMs (as opposed to pod VMs). In such case, CO support software 144 can include a CO agent that cooperates with a master server 148 to deploy pods 130 in pod VMs of VMs 140.

In embodiments, data center 101 communicates with a cloud 186 over WAN 191. Automation pipeline software 147 can execute in cloud 186 (e.g., a software-as-a-service (SaaS) or similar cloud software). Users can interact with automation pipeline software 147 in cloud 186 to manage pipelines that target data center 101 and/or pipelines that target cloud 186.

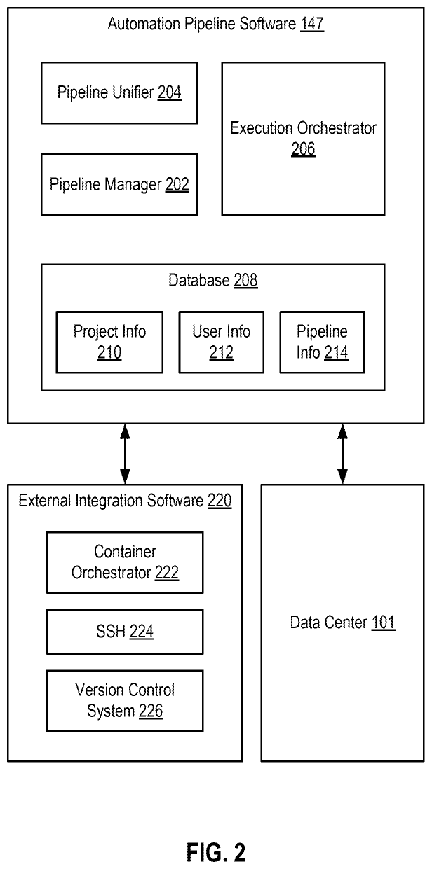

FIG. 2 is a block diagram depicting automation pipeline software 147 according to embodiments. Automation pipeline software 147 includes a pipeline manager 202, a pipeline unifier 204, an execution orchestrator 206, and a database 208. Automation pipeline software 147 can communicate with external integration software 220, such as a container orchestrator 222 (e.g., Kubernetes), a secure shell (SSH) 224, a version control system 226 (e.g., Git), among a myriad of other types of software used for application development, management, and deployment. Automation pipeline software 147 is also in communication with data center 101, such as virtualization management server 116, network manager 112, hosts 120, and the like.

A user interacts with pipeline manager 202 to create, update, delete, or otherwise manage pipelines. Database 208 can store pipeline information 214 that specifies different pipelines created by pipeline manager 202 (e.g., pipeline stages, tasks performed in each stage, endpoints associated with each task, and the like). The user can also associate each pipeline with a project. Database 208 can store project information 210 that specifies different projects with which pipelines can be associated. The user can also associate different principals with the pipeline, those principals having different roles, permissions, authorizations, and the like (e.g., principals with execute authority, principals with only view authority, etc.). A principal can be a user, group, or the like sourced from a directory server, single-sign on (SSO) server, or the like. Database 208 can store user information 212 that specifies different principals and associated information (e.g., which project(s) the principal with which the principal is/are associated). For example, a pipeline can be created to deploy a containerized application on cluster 118. The pipeline can include stage(s) for deploying virtualized infrastructure (e.g., VMs, SD network components, storage, etc.), stage(s) for deploying a CO cluster (e.g., master servers, worker nodes, etc.), and stage(s) for deploying the application on the CO cluster (e.g., container images, containers, etc.). Each pipeline stage can communicate with external integration software 220 and/or data center 101 to perform its task(s). A user interacts with execution orchestrator 206 to execute a pipeline. Execution orchestrator 206 can authenticate and verify authorization of the user for executing the pipeline. As described further below, a user can interact with pipeline manager 202 to mark some or all pipelines as “shared pipelines.”

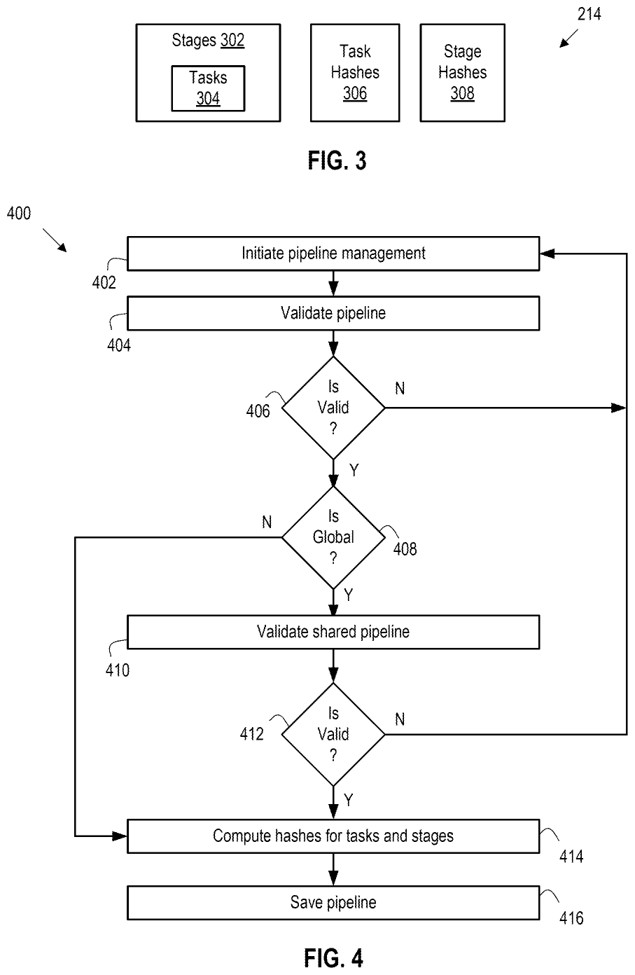

FIG. 3 is a block diagram depicting pipeline information 214 for a pipeline according to embodiments. Pipeline information 214 includes definitions for stages 302 of the pipeline and tasks 304 for stages 302. Each stage 302 has one or more tasks 304. Pipeline information 214 includes task hashes 306 and stage hashes 308, which are computed as described below.

FIG. 4 is a flow diagram depicting a method 400 of creating a pipeline according to embodiments. Method 400 begins at step 402, where a user interacts with pipeline manager 202 to initiate pipeline management (e.g., pipeline creation or editing an existing pipeline). The pipeline creation process includes definitions for its stages and definitions for its tasks performed in each of the stages. The pipeline editing process includes editing task(s) and/or stage(s). A task includes input parameters, logic to be executed given the input parameters, and optionally output parameters. Tasks can be arranged in a sequence within a stage. Alternatively, some tasks can be performed concurrently within a stage. Stages can be arranged in sequence. Alternatively, some stages can be performed concurrently. At step 404, pipeline manager 202 validates the pipeline. Pipeline validation includes checking the stages and tasks within a stage, the stage/task dependency, external integration software dependencies, etc. If at step 406 the pipeline is valid, method 400 proceeds to step 408. Otherwise, method 400 returns to step 402 so that the user can modify the pipeline definition.

At step 408, pipeline manager 202 determines if the pipeline is a global pipeline. In embodiments, a user can specify that a pipeline being created should be global. A global pipeline (or shared pipeline) can be shared across projects. If a pipeline is not flagged as global, the pipeline is associated with only a single project (e.g., local to one project). If at step 408 the pipeline is flagged as global, method 400 proceeds to step 410. Otherwise, method 400 proceeds to steep 414. At step 410, pipeline manager 202 validates the shared pipeline. These validation checks can include checks pertinent to shared pipelines that are not performed at step 404. Such checks can include, for example, checking for cyclic dependencies between shared pipelines, and checking if shared pipelines are in an enabled state so that they can be executed.

At step 412, pipeline manager 202 determines if the shared pipeline is valid. If not, method 400 returns to step 402 so that the user can modify the pipeline to correct the invalidity. Otherwise, if valid, method 400 proceeds to step 414. At step 414, pipeline manager 202 computes hash values for each task. The task hash value can be computed using the task input parameters, as described below. Pipeline manager 202 then computes a hash for each stage. The stage hash can be computed based on the hashes of its tasks. Pipeline manager 202 generates task hashes 306 and stage hashes 308. Pipeline manager 202 then saves the pipeline at step 416.

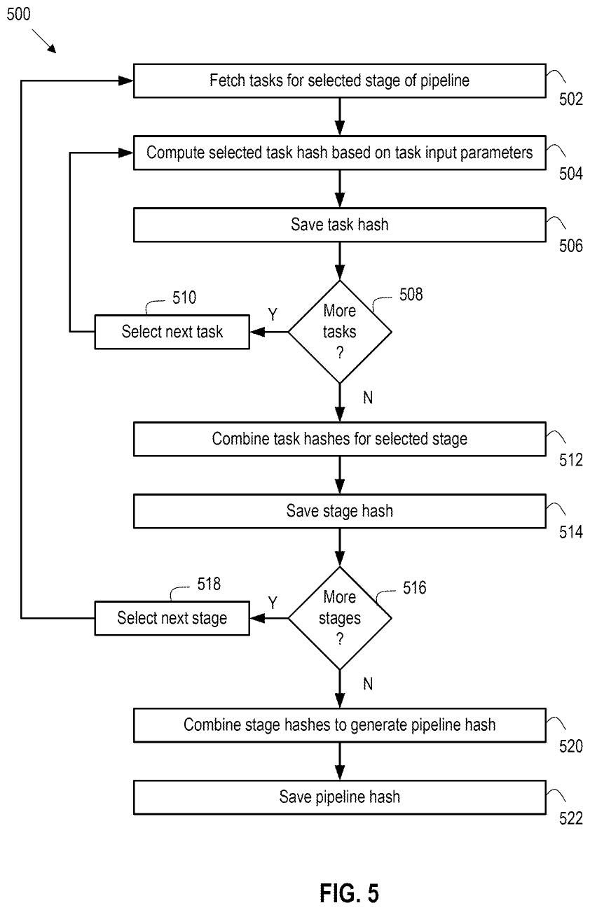

FIG. 5 is a flow diagram depicting a method 500 of generating hashes for a pipeline according to embodiments. Method 500 begins at step 502, where pipeline manager 202 fetches the tasks for a selected stage of the pipeline. At step 504, pipeline manager 202 computes a hash for a selected task based on the task input parameters. An example task is discussed below. At step 506, pipeline manager 202 saves the task hash in database 208. At step 508, pipeline manager 202 determines if there are more tasks to process for this selected stage. If so, method 500 proceeds to step 510 and selects the next task. Method 500 returns to step 504. If there are no more tasks to process at step 508, method 500 proceeds to step 512.

At step 512, pipeline manager 202 combines the task hashes for the selected stage to generate a stage hash. For example, pipeline manager 202 can concatenate the task hashes to form the stage hash. In another example, pipeline manager 202 can concatenate the task hashes and then generate another hash from the concatenation. At step 514, pipeline manager 202 saves the stage hash in database 208. At step 516, pipeline manager 202 determines if there are more stages to be processed. If so, method 500 proceeds to step 518. At step 518, pipeline manager 202 selects the next stage and returns to step 502. If there are no more stages to process, method 500 proceeds from step 516 to step 520.

At step 520, pipeline manager 202 combines the stage hashes to generate a pipeline hash. For example, pipeline manager 202 can concatenate the stage hashes to form the pipeline hash. In another example, pipeline manager 202 can concatenate the stage hashes and then generate another hash from the concatenation. At step 522, pipeline manager 202 saves the pipeline hash in database 208.

For example, consider a task having input parameters of: an input URL, a count value, an interval value, headers, a success condition, a failure condition, notifications, and a rollback value. With such parameters, there is a key and value (e.g., key for “count” and the count value). Pipeline manager 202 generates a string for the task in the form of {parameter_1_key}:{parameter_1_value}; {parameter_2_key}:{parameter_2_value}; . . . and so on. Pipeline manager 202 then generates a message digest with a cryptographic hash algorithm (e.g., MD5, SHA-256, etc.). Note that any cryptographic algorithm can be used and the techniques described herein are not limited to any particular technique for generating hash values. Pipeline manager 202 converts the identifier string for the task into a hash value representing the task. For a stage hash, pipeline manager 202 can concatenate the task hashes into an identifier string for the stage. Pipeline manager can generate a message digest with a cryptographic hash algorithm to convert the stage identifier string into a stage hash. Likewise for the pipeline hash using the stage hashes in a pipeline identifier string.

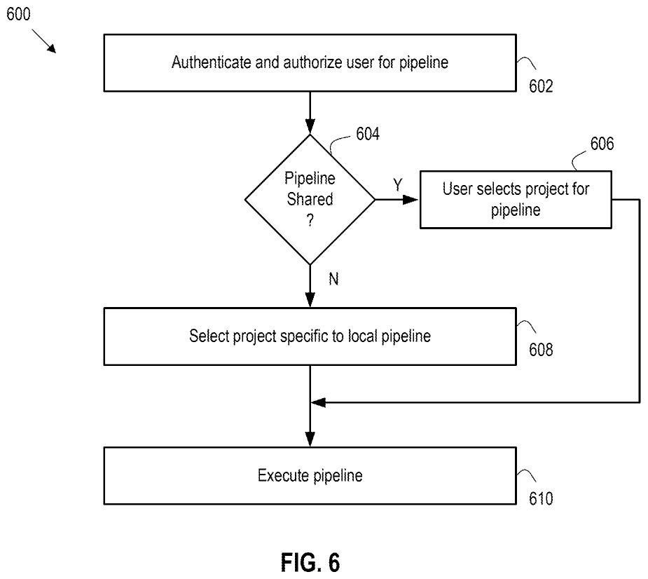

FIG. 6 is a flow diagram depicting a method 600 of executing a pipeline according to embodiments. Method 600 begins at step 602, where pipeline manager 202 authenticates and authorizes the user for executing the pipeline. At step 604, pipeline manager 202 determines if the pipeline is a global pipeline. If so, method 600 proceeds to step 606, where pipeline manager 202 receives a user selected project for the pipeline. Since the pipeline is shared, the pipeline can be executed in any project. If the pipeline is not shared (not global), method 600 proceeds from step 604 to step 608. At step 608, pipeline manager 202 selects the project that is associated with the local pipeline. At step 610, pipeline manager 202 executes the pipeline in the selected project.

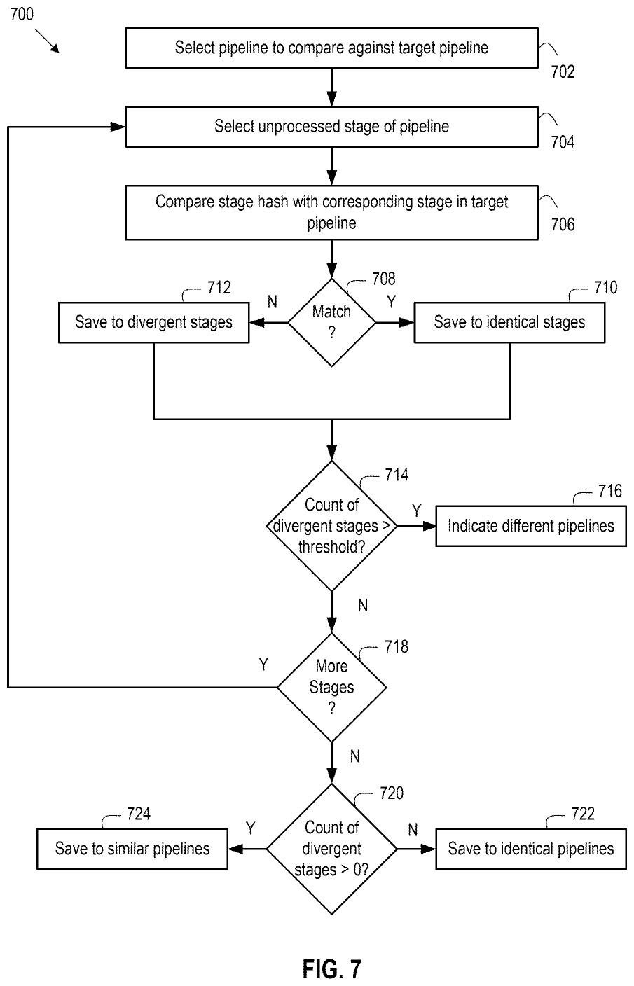

FIG. 7 is a flow diagram depicting a method 700 of comparing pipelines according to embodiments. Pipeline unifier 204 can execute method 700 to compare a pipeline with a target pipeline to determine if the pipelines are different, the same, or similar to one another. If the pipelines are the same, the user can designate one of the pipelines as a global pipeline and delete the other pipeline to reduce duplication of pipelines. The global pipeline can then be used across projects. If the pipelines are similar, the user can determine the degree of similarity between the pipelines (e.g., the number of matching stages). The user can then generate a global pipeline for the matching stages. The user can modify the compared pipelines to remove the stages that are now in the global pipeline. If the pipelines are different, then deduplication is not performed.

Method 700 begins at step 702, where pipeline unifier 204 selects a pipeline to compare against a target pipeline. At step 704, pipeline unifier 204 selects an unprocessed stage of the pipeline. At step 706, pipeline unifier 204 compares the stage hash with the hash of the corresponding stage in the target pipeline. At step 708, pipeline unifier 204 determines if there is a match. If so, method 700 proceeds to step 710, where pipeline unifier 204 saves the stages as identical stages. If at step 708 there is not a match, pipeline unifier 204 saves the stages as divergent stages. Method 700 proceeds to step 714.

At step 714, pipeline unifier 204 determines the count of divergent stages. If the count exceeds a threshold, method 700 proceeds to step 716, where pipeline unifier 204 indicates the pipeline is different from the target pipeline. If there are enough divergent stages, the pipeline are different and deduplication cannot be performed or would otherwise be inefficient. If the count of divergent stages is less than the threshold, method 700 proceeds from step 714 to step 718.

At step 718, pipeline unifier 204 determines if there are more stages to be processed. If so, method 700 returns to step 704. Otherwise, method 700 proceeds from step 718 to step 720. At step 720, pipeline unifier 204 determines the count of divergent stages. If the count is zero, method 700 proceeds to step 722, where pipeline unifier 204 indicates identical pipelines. If the count of divergent stages is greater than zero, method 700 proceeds from step 720 to step 724, where pipeline unifier 204 indicates similar pipelines.

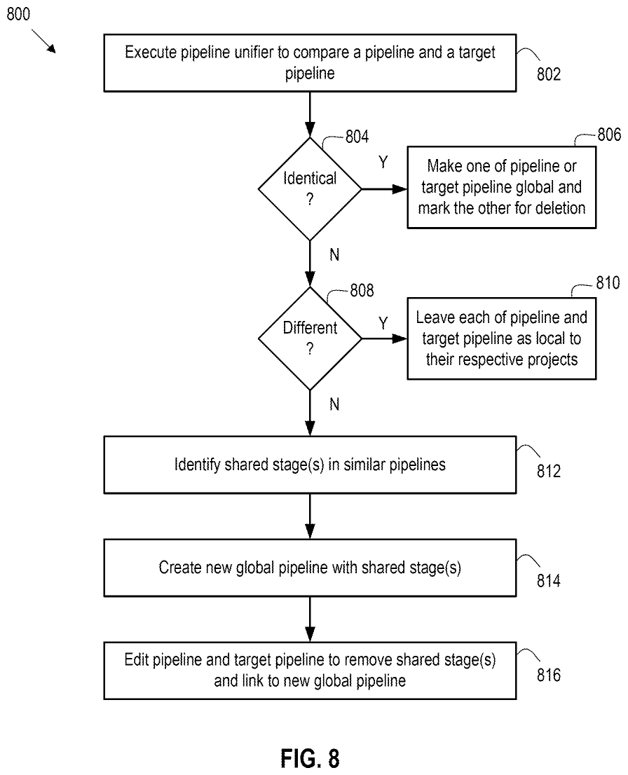

FIG. 8 is a flow diagram depicting a method 800 of comparing pipelines for unification according to embodiments. Method 800 begins at step 802, where a user or software executes pipeline unifier 204 to compare a pipeline and a target pipeline. Pipeline unifier 204 executes the process described above (method 700). At step 804, automation pipeline software 147 determines if the pipeline and the target pipeline are identical. If so, method 800 proceeds to step 806, where automation pipeline software 147 (automatically or with user interaction) makes one pipeline global and marks the other pipeline for deletion. If at step 804 the pipelines are not identical, method 800 proceeds to step 808. At step 808, automation pipeline software determines if the pipelines are different. If so, method 800 proceeds to step 810 and automation pipeline software 147 leaves each of the pipelines as local pipelines associated with their respective projects. If at step 808 the pipelines are not different, method 800 proceeds to step 812. In this case, the pipelines are similar. At step 812, automation pipeline software 147 identifies shared stage(s) in the similar pipelines. At step 814, automation pipeline software 147 creates a new global pipeline with the shared stages. At step 816, automation pipeline software 147 edits the pipeline and the target pipeline to remove the shared stage(s) and add links to the new global pipeline.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The terms computer readable medium or non-transitory computer readable medium refer to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that, unless otherwise stated, one or more of these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in user-space on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific configurations. Other allocations of functionality are envisioned and may fall within the scope of the appended claims. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing an automation pipeline in a computing system, comprising:
receiving, at a pipeline manager, a definition of the pipeline having a plurality of stages, each of the plurality of stages having at least one task;
receiving, at the pipeline manager, an indication that the pipeline is global across a plurality of projects;
receiving, at an execution orchestrator, a request from a user to execute the pipeline;
requesting, by the execution orchestrator from the user, a target project of the plurality of projects in which to execute the pipeline in response to the pipeline being global; and
executing, by the execution orchestrator, the pipeline in the target project to deploy an application executing on virtualized infrastructure of the computing system.

2. The method of claim 1, further comprising:
validating, by the pipeline manager, the definition of the pipeline.

3. The method of claim 1, wherein a stage of the plurality of stages includes a plurality of tasks, and wherein the method comprises:
computing, by the pipeline manager, a plurality of hashes from the plurality of tasks; and
storing, by the pipeline manager, the plurality of hashes in a database.

4. The method of claim 3, further comprising:
computing, by the pipeline manager, an identifier of the stage by combining the plurality of hashes.

5. The method of claim 1, further comprising:
computing, by the pipeline manager, an identifier for each of the plurality of stages from at least one hash value of the respective at least one task; and
computing, by the pipeline manager, an identifier of the pipeline by combining identifiers of the plurality of stages.

6. The method of claim 5, further comprising:
comparing, by a pipeline unifier, the identifiers of the plurality of stages against identifiers of a plurality of stages of a target pipeline;
determining, by the pipeline unifier, a number of divergent stages based on the comparison;
indicating, by the pipeline unifier, that the pipeline and the target pipeline are different in response to a number of the divergent stages being greater than a threshold.

7. The method of claim 5, further comprising:
comparing, by a pipeline unifier, the identifiers of the plurality of stages against identifiers of a plurality of stages of a target pipeline;
determining, by the pipeline unifier, a number of divergent stages based on the comparison;
indicating, by the pipeline unifier, that the pipeline and the target pipeline are identical in response to the number of divergent stages being equal to zero.

8. A non-transitory computer readable medium comprising instructions to be executed in a computing device to cause the computing device to carry out a method of managing an automation pipeline in a computing system, comprising:
receiving, at a pipeline manager, a definition of the pipeline having a plurality of stages, each of the plurality of stages having at least one task;
receiving, at the pipeline manager, an indication that the pipeline is global across a plurality of projects;
receiving, at an execution orchestrator, a request from a user to execute the pipeline;
requesting, by the execution orchestrator from the user, a target project of the plurality of projects in which to execute the pipeline in response to the pipeline being global; and
executing, by the execution orchestrator, the pipeline in the target project to deploy an application executing on virtualized infrastructure of the computing system.

9. The non-transitory computer readable medium of claim 8, further comprising:
validating, by the pipeline manager, the definition of the pipeline.

10. The non-transitory computer readable medium of claim 8, wherein a stage of the plurality of stages includes a plurality of tasks, and wherein the method comprises:
computing, by the pipeline manager, a plurality of hashes from the plurality of tasks; and
storing, by the pipeline manager, the plurality of hashes in a database.

11. The non-transitory computer readable medium of claim 10, further comprising:
computing, by the pipeline manager, an identifier of the stage by combining the plurality of hashes.

12. The non-transitory computer readable medium of claim 8, further comprising:
computing, by the pipeline manager, an identifier for each of the plurality of stages from at least one hash value of the respective at least one task; and
computing, by the pipeline manager, an identifier of the pipeline by combining identifiers of the plurality of stages.

13. The non-transitory computer readable medium of claim 12, further comprising:
comparing, by a pipeline unifier, the identifiers of the plurality of stages against identifiers of a plurality of stages of a target pipeline;
determining, by the pipeline unifier, a number of divergent stages based on the comparison;
indicating, by the pipeline unifier, that the pipeline and the target pipeline are different in response to a number of the divergent stages being greater than a threshold.

14. The non-transitory computer readable medium of claim 12, further comprising:
comparing, by a pipeline unifier, the identifiers of the plurality of stages against identifiers of a plurality of stages of a target pipeline;
determining, by the pipeline unifier, a number of divergent stages based on the comparison;
indicating, by the pipeline unifier, that the pipeline and the target pipeline are identical in response to the number of divergent stages being equal to zero.

15. A computer system, comprising:
a hardware platform; and
software, executing on the hardware platform, configured to:
receive, at a pipeline manager, a definition of a pipeline having a plurality of stages, each of the plurality of stages having at least one task;
receive, at the pipeline manager, an indication that the pipeline is global across a plurality of projects;
receive, at an execution orchestrator, a request from a user to execute the pipeline;
request, by the execution orchestrator from the user, a target project of the plurality of projects in which to execute the pipeline in response to the pipeline being global; and
execute, by the execution orchestrator, the pipeline in the target project to deploy an application executing on virtualized infrastructure of the computer system.

16. The computer system of claim 15, wherein a stage of the plurality of stages includes a plurality of tasks, and wherein the pipeline manager is configured to:
compute a plurality of hashes from the plurality of tasks; and
store the plurality of hashes in a database.

17. The computer system of claim 16, wherein the pipeline manager is configured to:
compute an identifier of the stage by combining the plurality of hashes.

18. The computer system of claim 15, wherein the pipeline manager is configured to:
compute an identifier for each of the plurality of stages from at least one hash value of the respective at least one task; and
compute an identifier of the pipeline by combining identifiers of the plurality of stages.

19. The computer system of claim 18, wherein a pipeline unifier is configured to:
compare the identifiers of the plurality of stages against identifiers of a plurality of stages of a target pipeline;
determine a number of divergent stages based on the comparison;
indicate that the pipeline and the target pipeline are different in response to a number of the divergent stages being greater than a threshold.

20. The computer system of claim 18, wherein a pipeline unifier is configured to:
compare the identifiers of the plurality of stages against identifiers of a plurality of stages of a target pipeline;
determine a number of divergent stages based on the comparison;
indicate that the pipeline and the target pipeline are identical in response to the number of divergent stages being equal to zero.
